(19) United States
(12) Patent Application Publication
(10) Pub. No.: US 2013/0275860 A1
(43) Pub. Date: Oct. 17, 2013

(54) SYSTEM AND METHOD FOR ASSISTING INFORMATION SEARCHING

(71) Applicant: SPIRORITY, INC., Sunnyvale, CA (US)

(72) Inventor: Phuong L. Tran, Sunnyvale, CA (US)

(73) Assignee: SPIRORITY, INC., Sunnyvale, CA (US)

(21) Appl. No.: 13/860,648

(22) Filed: Apr. 11, 2013

Related U.S. Application Data
(60) Provisional application No. 61/625,092, filed on Apr. 17, 2012.

(51) Int. Cl. G06F 17/30; G06F 17/22

(52) U.S. Cl. CPC G06F 17/30554; G06F 17/2247
USPC 715/234; 707/722

(57) ABSTRACT

Exemplary embodiments provide for assisting information searching. Aspect of the exemplary embodiments include responsive to monitoring the user performing one or more searches for information via a browser, obtaining a set of user search results, wherein the search results include various content types of search results; organizing and displaying the search results into one or more containers of search results; receiving an upload of contents from the user and saving the contents into the one or more containers for subsequent retrieval for subsequent retrieval; and allowing the user to share the one or more containers with another user, and in response to the other user performing one or more searches for information via browser, adding selected portions of the other user's search results to the one or more containers.

### CROSS-REFERENCE TO RELATED APPLICATIONS

This application claims the benefit of provisional Patent Application Ser. No. 61625092, filed Apr. 17, 2012, assigned to the assignee of the present application, and incorporated herein by reference.

### BRIEF SUMMARY

Exemplary embodiments provide for assisting information searching. Aspect of the exemplary embodiments include responsive to monitoring the user performing one or more searches for information via a browser, obtaining a set of user search results, wherein the search results include various content types of search results; organizing and displaying the search results into one or more containers of search results; receiving an upload of contents from the user and saving the contents into the one or more containers for subsequent retrieval for subsequent retrieval; and allowing the user to share the one or more containers with another user, and in response to the other user performing one or more searches for information via browser, adding selected portions of the other user's search results to the one or more containers.

### BRIEF DESCRIPTION OF SEVERAL VIEWS OF THE DRAWINGS

FIG. 1 is a network diagram depicting a client-server system, within which various example embodiments may be deployed.

FIG. 2 is a block diagram illustrating server-side application modules that, in various example embodiments, are provided as part of the networked system.

FIG. 3 is a block diagram illustrating example modules of client-side application modules.

FIG. 4 is a flowchart illustrating an exemplary method of enabling a user to share with an additional user a subset of a set of results of a search for particular information.

FIG. 5 is a flowchart illustrating an exemplary method of enabling a user to organize and mix results of a search for particular information for sharing with an additional user.

FIG. 6 is a flowchart illustrating an exemplary method of enabling a user to leverage a selected result of one or more searches for information completed by one or more additional users in order to complete a search for particular information.

FIG. 7 is a flowchart illustrating an exemplary method of notifying a user of an option to access results of searches completed by one or more users based on an assessment of a relevancy of the results to a search being conducted by the user and an assessment of a quality of the results of the completed searches.

FIG. 8 is a screenshot of an exemplary user interface showing a home page, here denoted as a “Community Page,” a public page, from which a user can navigate to various Albums.

FIG. 9 is a screenshot of a user interface such as may be displayed when the user clicks on the Album icon.

FIG. 10 is a screenshot of an exemplary user interface for saving a user-created Album.

FIG. 11 is a functional block diagram of machine in the example form of a computer system within which instructions for causing the machine to perform any one or more of the methodologies discussed herein may be executed.

### DETAILED DESCRIPTION

The exemplary embodiment relates to for assisting information searching. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

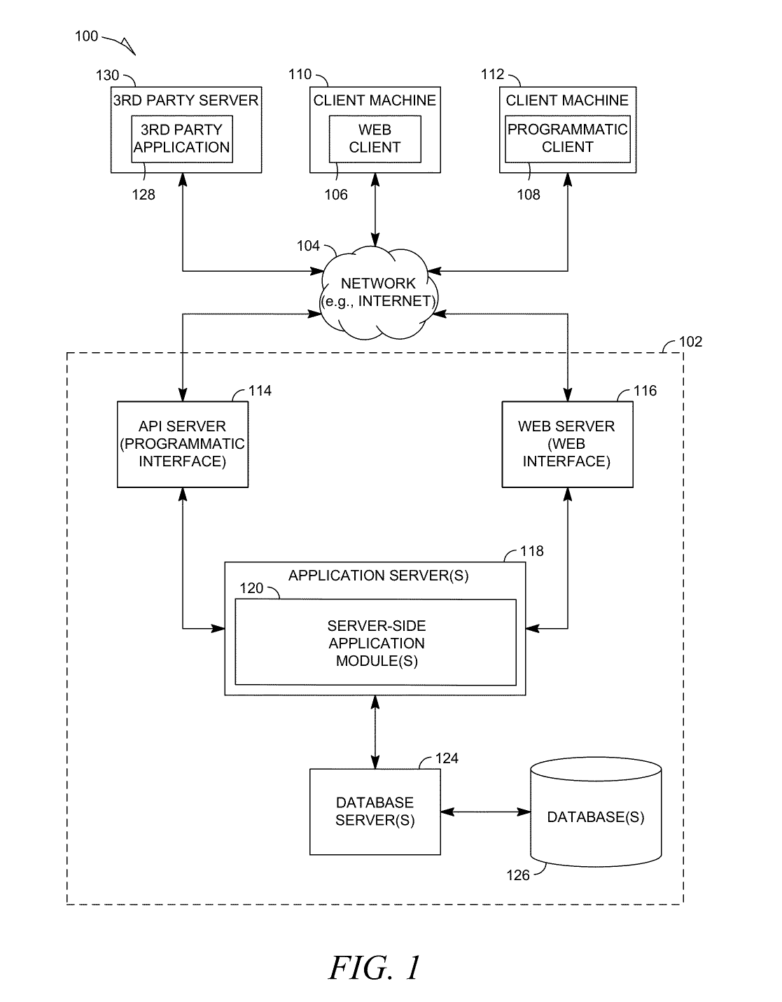

FIG. 1 is a network diagram depicting a client-server system 100, within which various example embodiments may be deployed. A networked system 102, in the example form community-based Internet system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash.) and a programmatic client 108 executing on respective client machines 110 and 112.

Each of the one or more clients may include a software application module (e.g., a plug-in, add-in, or macro) that adds a specific service or feature to a larger system. The software application module may be separate from but tightly-integrated into a user interface and functionality of a software application, such as a spreadsheet application. The software application may be a client software application executing on a client machine. The software application module may be optionally deployed in the same environment as the software application such that the software application module can be accessed from within the software application. The software application module may be optionally enabled or disabled within the environment (e.g., user interface) of the software application. The software application module may appear to be a part of the software application by, for example, providing user interface components or widgets (e.g., menus, toolbars, menu commands, toolbar commands, and so on) that can be enabled, disabled, added to, or removed from standard user interface components or widgets provided by the software application.

An API server 114 and a web server 116 are coupled to, and provide programmatic and web interfaces respectively to, one or more application servers 118. The application servers 118 host one or more server-side application modules 120. The application servers 118 are, in turn, shown to be coupled to one or more database servers 124 that facilitate access to one or more databases 126 or NoSQL or non-relational data stores.

While the system 100 shown in FIG. 1 employs a client-server architecture, various embodiments are, of course, not limited to such an architecture, and could equally well find application in a distributed, or peer-to-peer, architecture system, for example. The various server-side application modules 120 could also be implemented as standalone software programs, which do not necessarily have networking capabilities. Additionally, although FIG. 1 depicts machines 130, 110, and 112 as being coupled to a single networked system 102, it will be readily apparent to one skilled in the art that machines 130, 110, and 112, as well as application 128 and clients 106 and 108, may be coupled to multiple networked systems.

The web client 106 accesses the various server-side application modules 120 via the web interface supported by the web server 116. Similarly, the programmatic client 108 accesses the various services and functions provided by the server-side application modules 120 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third-party application 128, executing on a third-party server machine 130, as having programmatic access to the networked system 102 via the programmatic interface provided by the API server 114. For example, the third-party application 128 may, utilizing information retrieved from the networked system 102, support one or more features or functions on a website hosted by the third party. The third-party website may, for example, provide one or more promotional, marketplace or payment functions that are supported by the relevant applications of the networked system 102.

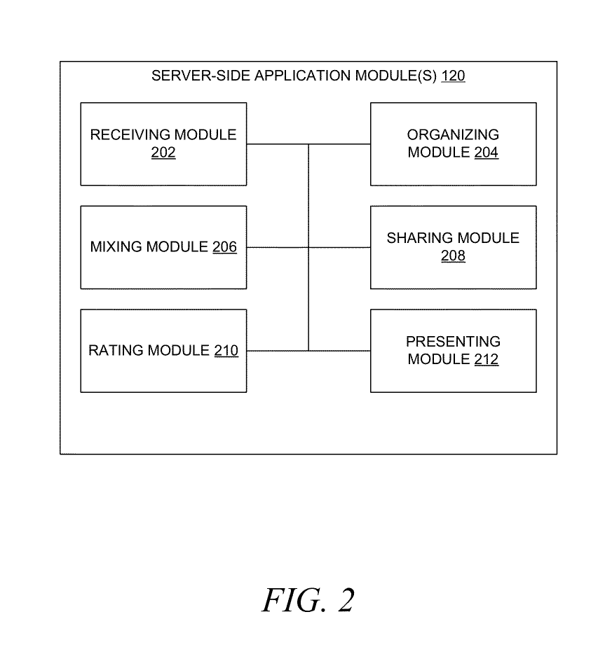

FIG. 2 is a block diagram illustrating server-side application modules 120 that, in various example embodiments, are provided as part of the networked system 102. The application modules 120, including a receiving module 202, an organizing module 204, a mixing module 206, a sharing module 208, a rating module 210, and a presenting module 212, may be hosted on dedicated or shared server machines (not shown) that are communicatively coupled to enable communications between server machines. The server-side application modules 120 themselves are communicatively coupled (e.g., via appropriate interfaces) to each other and to various data sources, so as to allow information to be passed between the server-side application modules 120 or so as to allow the server-side application modules 120 to share and access common data. The server-side application modules 120 may furthermore access one or more databases 126 via the database server(s) 124.

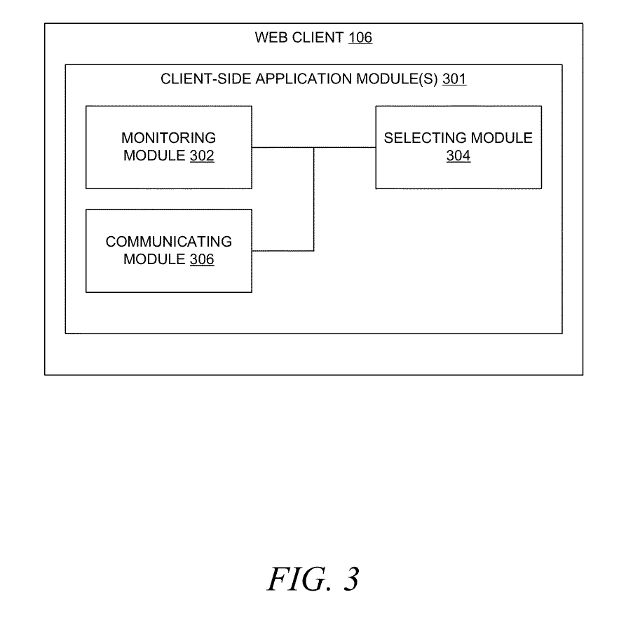

FIG. 3 is a block diagram illustrating example modules of client-side application modules 301 (e.g., a plug-in installed within an Internet browser application of a client machine) configured to enable a user of the software application module 301, including a monitoring module 302, a selecting module 304, and a communicating module 306, to access or manage the sharing of information search results with users of the networked system 102. Although the software application module 301 is depicted as being included in the web client 106, one skilled in the art would understand that the software application module 301 may just as easily be included in another client, such as the programmatic client 108 or the third-party application 128. One skilled in the art would also understand that the software application module 301 could just as easily be a standalone software application.

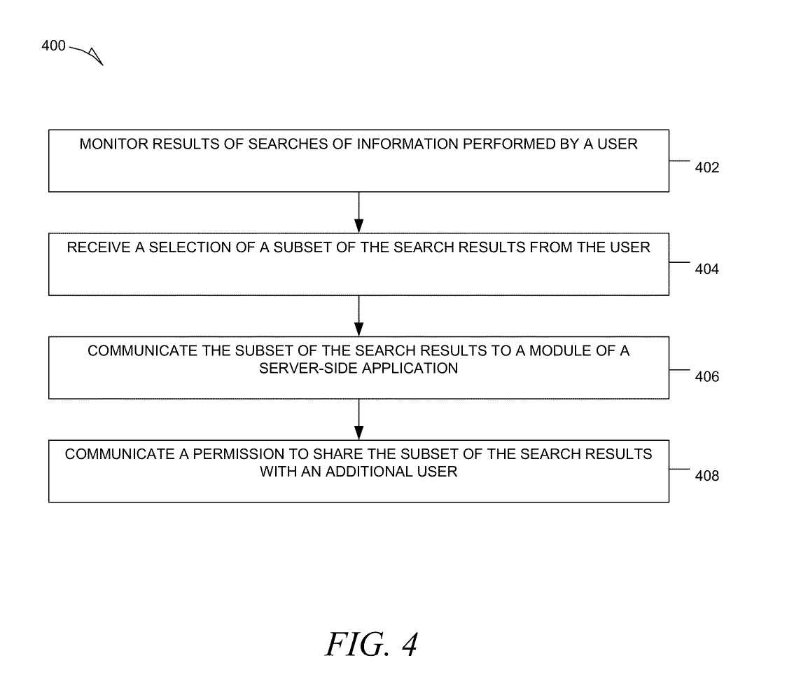

FIG. 4 is a flowchart illustrating an exemplary method 400 of enabling a user to share with an additional user a subset of a set of results of a search for particular information. The user may perform one or more searches for information, which action may be monitored by the application modules 120, at step 402. A selected group of one or more search results is generated by the user as a subset of the search results, at step 404. This search result subset is conveyed to the application modules 120, as step 406. In an exemplary embodiment, the search result subset may be shared with one or more additional users, at step 408.

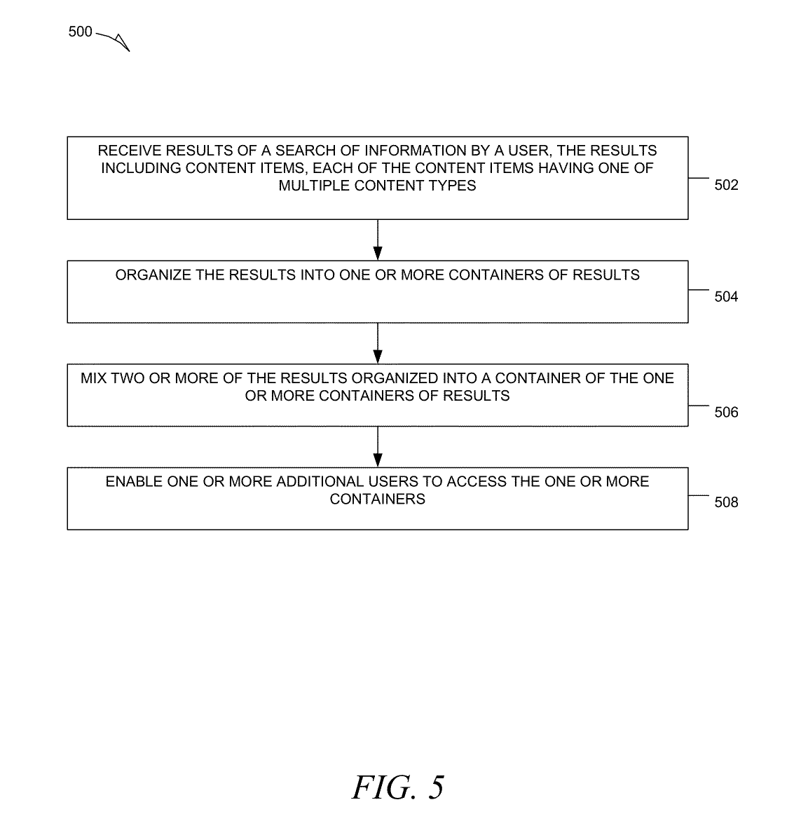

FIG. 5 is a flowchart illustrating an exemplary method 500 of enabling a user to organize and mix results of a search for particular information for sharing with an additional user. A set of user search results are obtained, at step 502. These search results may include, for example, various content types of search results, one or more of the content types comprising a particular type of a plurality of content types. The search results may be organized into one or more “containers” of search results, at step 504. Two or more of the search results may then be organized into one or more of the containers of search results, at step 506. One or more additional users may be enabled or authorized to access one or more of the search result containers created, at step 508.

In an exemplary embodiment, the container of search results may be displayed as a formatted aggregation of search results or web pages found in the user search. In the present disclosure, the search results in a container may share some common feature, theme, or concept created by the user, and may alternatively be referred to as an “Album.” For example, the user may search for and aggregate into an Album: the web pages of various musical videos found on a website such as YouTube; (ii) the web pages related to a particular sport, such as tennis; or, (iii) a particular pastime enjoyed by the user, such as bird watching.

The present invention allows a user to upload contents such as multiple images, video, contacts, and messages, Internet sites, and documents in an Album. For example, a user visiting a zoo can send an entire “Spiral Album” or a “Cylindrical Album” to an Internet site, as described in greater detail below, and thus better relate details of the visit than with a few images or a single video. In an exemplary embodiment, the present invention may assist a user that may be conducting research or similar tasks on the Internet, to save relevant Internet sites, text, images, or video contents, and documents into an Album in order to more easily retrieve the content later, or to share the Album with other users.

Accordingly, a musical enthusiast may create a Classical Music Album, a Reggae Album, a Blues Album, and a World Music Album. Each Album may include web pages related to music videos, biographical pages of musicians, sources for rare recordings, a website displaying music album art, sources for purchasing tickets for musical event, and the like. The user can thus share his Blues Album, for example, with a friend who also shares an interest in Blues music, but who has not had the time to search for particular musical videos or related web sites on his own. The friend may then conduct his own search and add his own selections to the Blues Album that the user originally shared with the friend.

Alternatively, the user may offer one or more of his Albums “for sale” on a website. A purchaser of the user Album would thus receive value from his purchase by obtaining a desired set of search results, without having had to conduct a similar search himself. The present invention may provide a marketing agent to enable the user creating a particular Album to share or sell the Album content. Alternatively, one or more third-party web sites may cooperate to display a user Album for use and possible purchase.

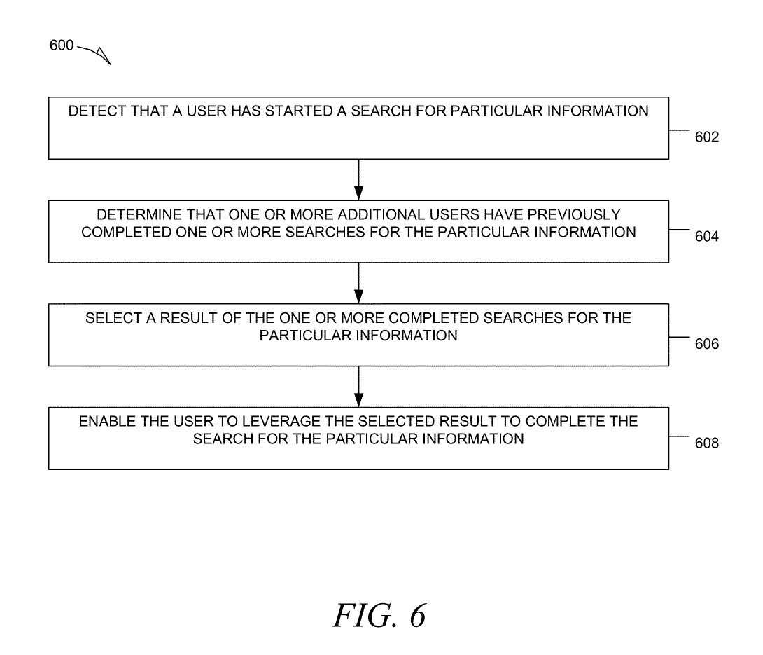

FIG. 6 is a flowchart illustrating an exemplary method 600 of enabling a user to leverage a selected result of one or more searches for information completed by one or more additional users in order to complete a search for particular information. The application modules 120 may detect that a search has been started by the user, at step 602. It may be further determined by the application modules 120, at step 604, that one or more other users had previously executed and completed searches for the same information being sought in the search of the present user. One of the previously-conducted searches may be selected, at step 606, and the selected result may be “leveraged” by the present user to enhance or complete the current search effort, at step 608.

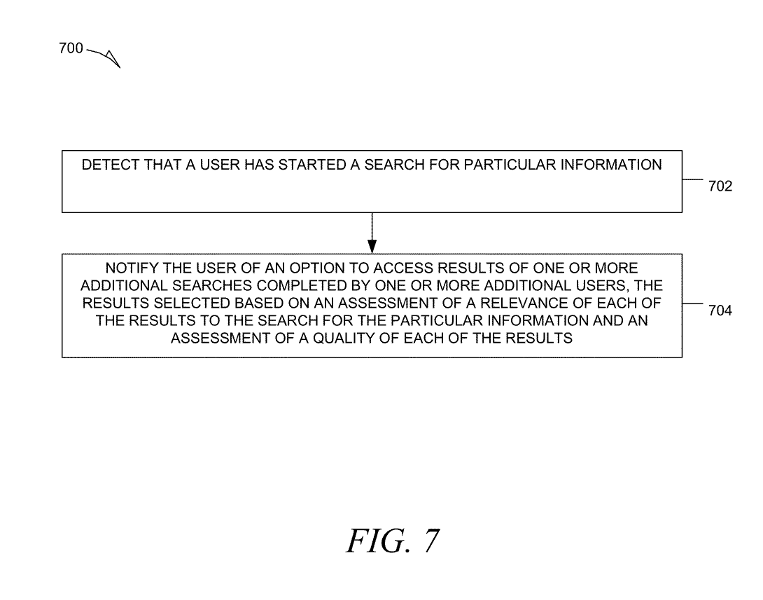

FIG. 7 is a flowchart illustrating an exemplary method 700 of notifying a user of an option to access results of searches completed by one or more users based on an assessment of a relevancy of the results to a search being conducted by the user and an assessment of a quality of the results of the completed searches. The application modules 120 may detect that a present user has begun a search for particular specified information, at step 702.

In response, the application modules 120 may function to notify the present user that an option to search archive material exists, whereby the present user can access the results of one or more previously conducted searches by one or more other users, at step 704. The application modules 120 may assess the relevance of the previous searches, with respect to the specified information of the present user. In an exemplary embodiment, the application modules 120 may further assess the quality of the previous searches to provide the present user with a quality ranking for the previous results in addition to the relevance of the previous search results.

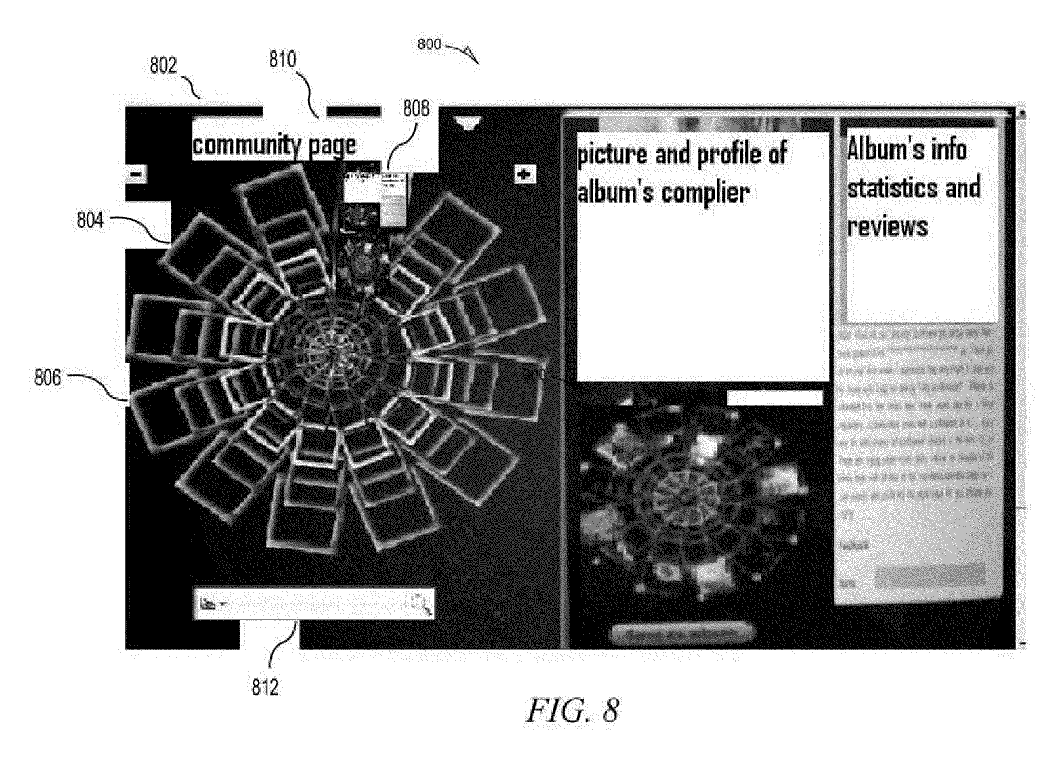

FIG. 8 is a screenshot of an exemplary user interface 800 showing a home page 802, here denoted as a “Community Page,” a public page, from which a user can navigate to various Albums, as described in greater detail below. In a typical application, the user can access the user interface 800 to determine, for example, the selection and arrangement of Albums to be displayed in the “top tier,” or uppermost group, of a community page array 804, as well as the selection and arrangement of user Albums to be displayed in other sections of the community page array 804. An upper search box 810 may be used to search for internal contents (e.g., Albums), such as YouTube Album, Picture Album, Search Album, etc. A lower search box 812 may be used for external, web searching using, for example, YouTube searching, All Search, Bing, and Google search.

For example, any user accessing YouTube and similar media sites can appreciate the fact that there exists a vast quantity of video clips and pages and images, as there are thousands of video clips for one song, for example, which may be uploaded by professionals and amateurs alike. The time required to sieve through this vast compilation of information is thus tremendously abridged for a user accessing the present invention. Users are thus enabled to select and share the results of their selections and compilations. Moreover, this invention may create an environment in which a community of co-Compilers of a given Album or a given topic may flourish. This action may thus help the Internet community to navigate through the vastness of web-related information and resources.

In the example shown in FIG. 8, an aggregate of Albums found in a user collection may be displayed in a corresponding plurality of “frames” 806 preferably arranged in a series of concentric circles. The concentric circles are seen to define the “inside surface” of a virtual cylindrical tube. Each frame 806 in any one circle of frames 806 is partially overlapped by a smaller frame 806 in a smaller, adjacent circle of frames 806. The largest frames 806 thus comprise the outermost circle, and the search array 804 is configured such that it appears to the user that he is looking into the interior of the virtual cylindrical tube.

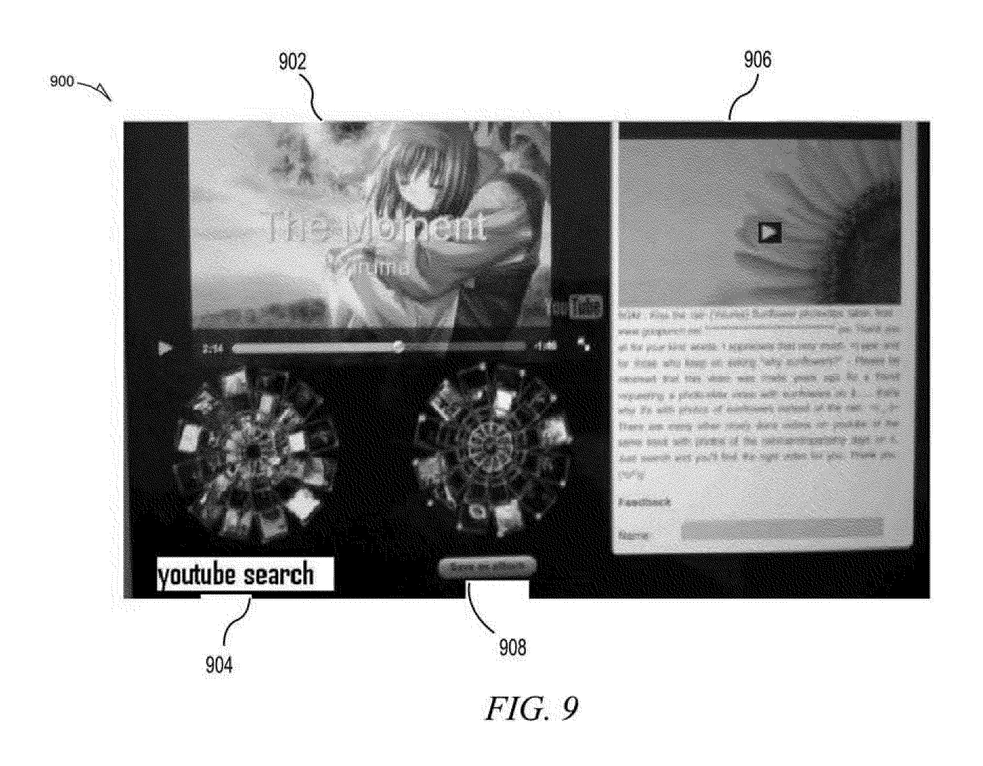

An Album icon 808 may be placed within any one of the frames 806. The Album icon 808 comprises an active link to a corresponding user Album by which a user can access and open the corresponding Album for viewing or editing, as shown in FIG. 9. In the example provided, the Album icon 808 corresponds to an Album that may include, for example, entries in the results of a search for musical videos, such as may be found on a music video website such as YouTube. In an exemplary embodiment, the present invention may enable a user to navigate, mix content, control the flow of an Album (e.g., play, skip, mute, pause) by voice, sound, gestures, or by combinations of voice, sound and gestures.

In an alternative embodiment, the search array 804 may be formatted as a virtual spiral (not shown) descending into the virtual plane of the home page 802. The top, outermost segment, or “arm,” of the virtual spiral configuration thus comprises the set of Album icons 808 positioned furthest from the center of the spiral, and correspondingly, appear closer to the user. Thus, the user may display the more relevant, or pertinent, Album icons 808 in the outer arm of the virtual spiral configuration, or in the outermost circle of the cylindrical configuration. In both the cylindrical configuration and the spiral configuration, each of the Album icons 808 disposed within a respective frame 806 comprises an active link such that clicking on a particular Album icon 808 brings up the contents of the corresponding user Album.

FIG. 9 is a screenshot of a user interface 900 such as may be displayed when the user clicks on the Album icon 808, shown in FIG. 8. Alternatively, the user may select a “search” or “enter” button (not shown) on the home page 802 to bring up the user interface 900. A web page 902 may be displayed in a region on the display screen of the user previously showing the home page 802. In the example provided, a YouTube page in a main panel 902 may include a YouTube search box 904 to enable the user to search and add different video segments to the current Album before “saving” the Album.

A video clip found in a search, here shown in a side panel 906, can be played in mute, for example. This feature allows the user to watch and hear music in the main panel 902, while watching a sport video, for example, in the side panel 906. In an exemplary embodiment, the user can compare the same video or song from different sources, by placing one version of the song in the main panel 902 and the other version of the song in the side panel 906. After hitting a “Save as Album” button 908, the Album displayed in the main panel 902 may be saved to a “My Library” array 1002.

The present invention may alternatively help a user to combine and/or mix the contents of various information resources to create a new and improved enhanced content. For example, the user can mix different videos of individual instruments to create a mix video of an orchestra recording, or the user can add the news article of an old world record to the breaking-news of a current world record of a sporting event. By way of example, a user may select the contents from various YouTube video clips, and then share these contents with other users as an Album. In another example, a user may research the solution for a research question. This solution might comprise a collection of many pages from a plurality of web sites, and may include video clips and digital images. The user may save all these web site documents into a Research Album. If a subsequent user begins a search in the same, or similar, research topic, the subsequent user can add on to the original Research Album and make his own comments, while and continuing to share with even more users. In this way, the various users can become Album Compilers and Album co-Compilers for a specified topic on the Internet.

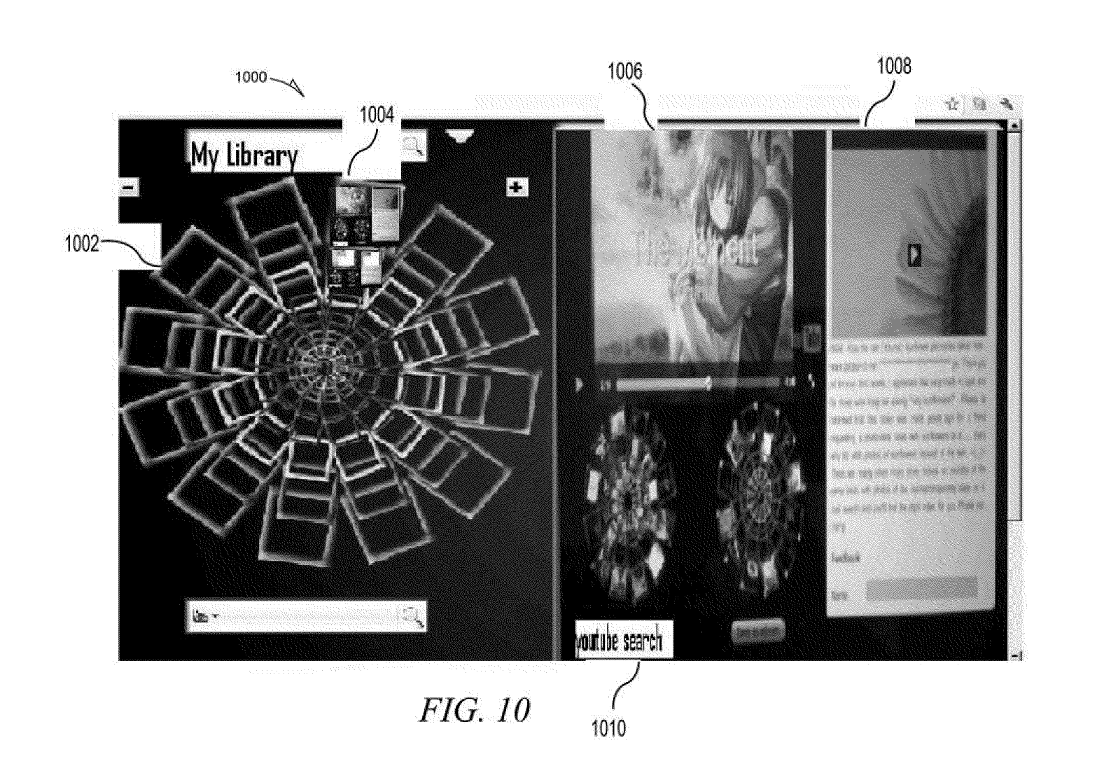

FIG. 10 is a screenshot of an exemplary user interface 1000 for saving a user-created Album. A user may store and search for one or more saved Albums via the user interface 900. When the user “mouses” a cursor over an Album icon 1004, the corresponding Album is shown in a first side panel 1006. In an exemplary embodiment, the Album name and information may also be provided in a second side panel 1008. The user may click a “YouTube” button 1010 to open the corresponding YouTube page 902, shown in FIG. 9. When the user selects a “saved” operation, the current Album may be placed into the My Library array 1002 as a private page. Alternatively, if the user selects a “shared” operation, the current Album may be placed in the Community Page array 804, shown in FIG. 8, as a public page. It can be appreciated that the present invention may assist a user to associate comments with specific information, a selected image, or relevant video, and as well as enabling a user to save such inputs for later use, or to share the search results with other users.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

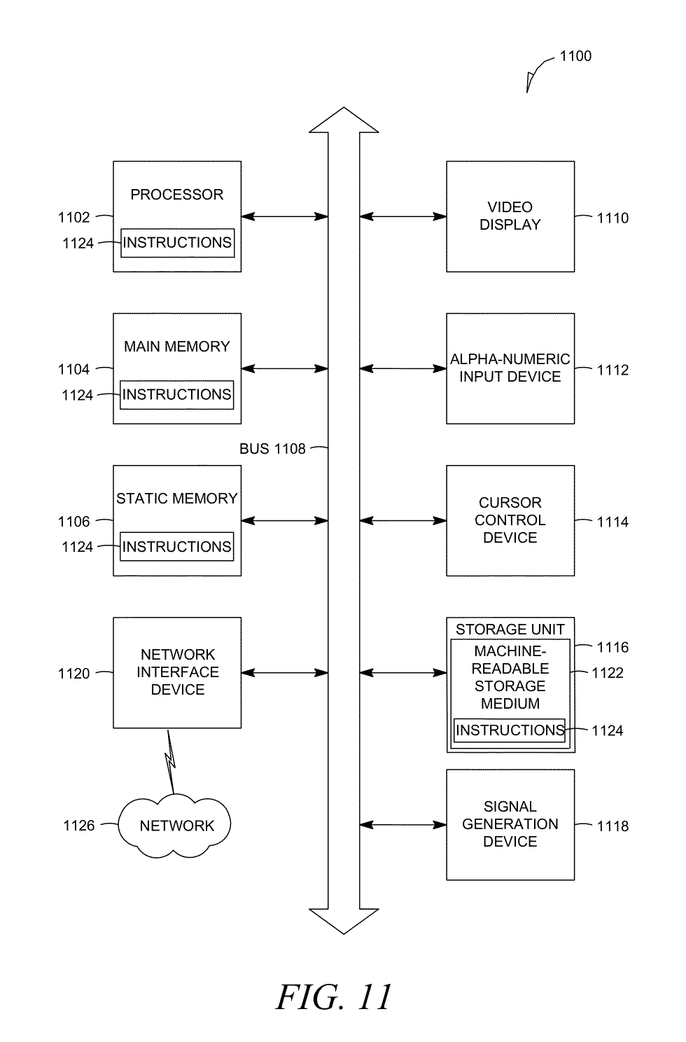

FIG. 11 is a functional block diagram of machine in the example form of a computer system 1100 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may comprise a personal computer (PC), a laptop computer, a tablet PC, a set-top box (STB), a Personal Digital Assistant (PDA), a SmartPhone, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD), a touch screen, or a cathode ray tube (CRT)). The computer system 1100 also includes an alphanumeric input device 1112 (e.g., a keyboard, or a virtual keyboard in a touch screen), a user interface (UI) navigation (or cursor control) device 1114 (e.g., a mouse), a storage (e.g., disk drive) unit 1116, a signal generation device 1118 (e.g., a speaker) and a network interface device 1120.

The disk drive unit 1116 includes a machine-readable medium 1122 on which is stored one or more sets of data structures and instructions (e.g., software) embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media. The instructions 1124 may also reside, completely or at least partially, within the static memory 1106.

While the machine-readable medium 1122 is shown in an exemplary embodiment to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a LAN, a WAN, the Internet, mobile telephone networks, POTS networks, and wireless data networks (e.g., Wi-Fi and Wi-Max networks). The term “transmission medium” shall be taken to include any intangible medium capable of storing, encoding or carrying instructions for execution by the machine, and includes digital or analog communications signals or other intangible media to facilitate communication of such software. The network 1126 may comprise the network 104.

A method and system for assisting information searching has been disclosed. The present invention has been described in accordance with the embodiments shown, and there could be variations to the embodiments, and any variations would be within the spirit and scope of the present invention. For example, the exemplary embodiment can be implemented using hardware, software, a computer readable medium containing program instructions, or a combination thereof. Software written according to the present invention is to be either stored in some form of computer-readable medium such as a memory, a hard disk, or a CD/DVD-ROM and is to be executed by a processor. Accordingly, many modifications may be made by one of ordinary skill in the art without departing from the spirit and scope of the appended claims.

What is claimed is:

1. A method for assisting information searching, the method performed by at least one software component executing on at least one processor, the method comprising:
responsive to monitoring the use performing one or more searches for information via a browser, obtaining a set of user search results, wherein the search results include various content types of search results;
organizing and displaying the search results into one or more containers of search results;
receiving an upload of contents from the user and saving the contents into the one or more containers for subsequent retrieval for subsequent retrieval; and
allowing the user to share the one or more containers with another user, and in response to the other user performing one or more searches for information via browser, adding selected portions of the other user's search results to the one or more containers.

2. The method of claim 1, further comprising: displaying the one or more containers as one or albums on a community webpage.

3. The method of claim 2, further comprising: displaying the one or more albums in a community page array.

4. The method of claim 3, further comprising: providing the community page array with a plurality of frames.

5. The method of claim 4, further comprising: arranging the plurality of frames as at least a series of concentric circles and a virtual spiral the descending into a virtual plane of a home page.

6. The method of claim 5, further comprising: displaying most pertinent search results in an outermost circle of the concentric circles or in an outer arm of the virtual spiral.

7. The method of claim 5, wherein each of the frames in any one circle of frames is partially overlapped by a smaller frame in a smaller adjacent circle of frames.

8. The method of claim 5, further comprising: displaying an album icon within any one of the frames, wherein the album icon comprises an active link to a corresponding album.

9. The method of claim 8, further comprising: in response to a user placing a cursor over the album icon, displaying a corresponding album in a first side panel adjacent to the community page array.

10. The method of claim 3, further comprising: displaying adjacent to the community page array a first search box to be used to search for internal contents of albums.

11. The method of claim 10, further comprising: displaying adjacent to the community page array a second search box to be used for external website searching.

12. The method of claim 1, further comprising: enabling the user to offer the one or more containers for sale on a website.

13. The method of claim 1, wherein the content types comprise images, video, contacts, messages, Internet sites, and documents.

14. The method of claim 1, further comprising:
in response to detecting that the user has begun a search for specified information, notifying the user that an option to search archive materials; and
displaying results of one or more previously conducted searches by one or more of the users for user access.

15. An executable software product stored on a computer-readable storage medium containing program instructions for assisting information searching, the program instructions for:
responsive to monitoring a user performing one or more searches for information via a browser, obtaining a set of user search results, wherein the search results include various content types of search results;
organizing and displaying the search results into one or more containers of search results;
receiving an upload of contents from the user and saving the contents into the one or more containers for subsequent retrieval for subsequent retrieval; and
allowing the user to share the one or more containers with another user, and in response to the other user performing one or more searches for information via browser, adding selected portions of the other user's search results to the one or more containers.

16. The machine readable storage medium of claim 15, further comprising program instructions for: displaying the one or more containers as one or albums on a community webpage.

17. The machine readable storage medium of claim 16, further comprising program instructions for: displaying the one or more albums in a community page array.

18. The machine readable storage medium of claim 17, further comprising program instructions for: providing the community page array with a plurality of frames.

19. The machine readable storage medium of claim 18, further comprising program instructions for: arranging the plurality of frames as at least a series of concentric circles and a virtual spiral the descending into a virtual plane of a home page.

20. The machine readable storage medium of claim 19, further comprising program instructions for: displaying most pertinent search results in an outermost circle of the concentric circles or in an outer arm of the virtual spiral.

21. The machine readable storage medium of claim 19, wherein each of the frames in any one circle of frames is partially overlapped by a smaller frame in a smaller adjacent circle of frames.

22. The machine readable storage medium of claim 19, further comprising program instructions for: displaying an album icon within any one of the frames, wherein the album icon comprises an active link to a corresponding album.

23. The machine readable storage medium of claim 22, further comprising program instructions for: in response to a user placing a cursor over the album icon, displaying a corresponding album in a first side panel adjacent to the community page array.

24. The machine readable storage medium of claim 17, further comprising program instructions for: displaying adjacent to the community page array a first search box to be used to search for internal contents of albums.

25. The machine readable storage medium of claim 24, further comprising program instructions for: displaying adjacent to the community page array a second search box to be used for external website searching.

26. The machine readable storage medium of claim 15, further comprising program instructions for: enabling the user to offer the one or more containers for sale on a website.

27. The machine readable storage medium of claim 15, wherein the content types comprise images, video, contacts, messages, Internet sites, and documents.

28. The machine readable storage medium of claim 15, further comprising program instructions for:
in response to detecting that the user has begun a search for specified information, notifying the user that an option to search archive materials; and
displaying results of one or more previously conducted searches by one or more of the users for user access.

29. A system, comprising:
a memory;
a processor coupled to the memory; and
a software component executed by the processor that is configured to:
responsive to monitoring a user performing one or more searches for information via a browser, obtain a set of user search results, wherein the search results include various content types of search results;
organize and display the search results into one or more containers of search results;
receive an upload of contents from the user and saving the contents into the one or more containers for subsequent retrieval for subsequent retrieval; and
allow the user to share the one or more containers with another user, and in response to the other user performing one or more searches for information via browser, add selected portions of the other user's search results to the one or more containers.
